(19) United States
(12) Patent Application Publication
(10) Pub. No.: US 2025/0389812 A1
(43) Pub. Date: Dec. 25, 2025

(54) ANTENNA ARRAY CALIBRATION FOR A SPHERICAL WAVEFRONT-BASED COMMUNICATIONS SYSTEM

(71) Applicant: QUALCOMM Incorporated, San Diego, CA (US)

(72) Inventors: Vasanthan RAGHAVAN, West Windsor Township, NJ (US); Yu-Chin OU, San Diego, CA (US); Andrew ARNETT, San Diego, CA (US)

(21) Appl. No.: 18/752,326

(22) Filed: Jun. 24, 2024

(51) Int. Cl. G01S 7/40; G01S 13/74; H04B 17/12

(52) U.S. Cl. CPC G01S 7/40; G01S 13/74; H04B 17/12

(57) ABSTRACT

Methods, systems, and devices for wireless communications are described. A user equipment (UE) may communicate one or more reference signals to identify that communication with a second device is in a near field of the second device. The UE may determine, based on the communication with the second device being in the near field, a phase calibration adjustment for a first phase value associated with a far field. The UE may transmit, based on the communication with the second device being in the near field, a message according to the first phase value and the phase calibration adjustment.

### FIELD OF TECHNOLOGY

The following relates to wireless communications, including antenna array calibration for a spherical wavefront-based communications system.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include communicating one or more reference signals to identify that communication with a second device is in a near field of the second device, determining, based on the communication with the second device being in the near field, a phase calibration adjustment for a first phase value associated with a far field, and transmitting, based on the communication with the second device being in the near field, a message according to the first phase value and the phase calibration adjustment.

A UE for wireless communications is described. The UE may include one or more memories storing processor executable code, and one or more processors coupled with the one or more memories. The one or more processors may individually or collectively be operable to execute the code to cause the UE to communicate one or more reference signals to identify that communication with a second device is in a near field of the second device, determine, based on the communication with the second device being in the near field, a phase calibration adjustment for a first phase value associated with a far field, and transmit, based on the communication with the second device being in the near field, a message according to the first phase value and the phase calibration adjustment.

Another UE for wireless communications is described. The UE may include means for communicating one or more reference signals to identify that communication with a second device is in a near field of the second device, means for determining, based on the communication with the second device being in the near field, a phase calibration adjustment for a first phase value associated with a far field, and means for transmitting, based on the communication with the second device being in the near field, a message according to the first phase value and the phase calibration adjustment.

A non-transitory computer-readable medium storing code for wireless communications is described. The code may include instructions executable by one or more processors to communicate one or more reference signals to identify that communication with a second device is in a near field of the second device, determine, based on the communication with the second device being in the near field, a phase calibration adjustment for a first phase value associated with a far field, and transmit, based on the communication with the second device being in the near field, a message according to the first phase value and the phase calibration adjustment.

In some examples of the method, UEs, and non-transitory computer-readable medium described herein, determining the phase calibration adjustment may include operations, features, means, or instructions for receiving a reference signal associated with a first phase based on the communication with the second device being in the near field and measuring a phase response of the reference signal over one or more antenna elements of the UE, where the phase calibration adjustment may be based on the phase response of the reference signal.

In some examples of the method, UEs, and non-transitory computer-readable medium described herein, determining the phase calibration adjustment may include operations, features, means, or instructions for receiving a first reference signal associated with a first phase based on the communication with the second device being in the near field, transmitting a second reference signal associated with the first phase based on the first reference signal associated with the first phase, and receiving a feedback message indicating a phase deviation between the first reference signal and the second reference signal, where the phase calibration adjustment may be based on the phase deviation.

In some examples of the method, UEs, and non-transitory computer-readable medium described herein, determining the phase calibration adjustment may include operations, features, means, or instructions for determining, for each of a set of multiple sets of phase values associated with far field communications, a corresponding phase calibration adjustment.

In some examples of the method, UEs, and non-transitory computer-readable medium described herein, the phase calibration adjustment may be based on an ambient temperature, a temperature associated with the UE, a gain state of the UE, a radio frequency spectrum band used to transmit the message, a dimension of an antenna array of the UE, or any combination thereof.

In some examples of the method, UEs, and non-transitory computer-readable medium described herein, communicating the one or more reference signals may include operations, features, means, or instructions for receiving a reference signal, where a measurement of the reference signal may be indicative that a position of the UE corresponds to being in the near field.

Some examples of the method, UEs, and non-transitory computer-readable medium described herein may further include operations, features, means, or instructions for transmitting a control message indicating that a position of the UE may have changed from the far field of the second device to the near field of the second device, where determining the phase calibration adjustment may be based on the control message.

In some examples of the method, UEs, and non-transitory computer-readable medium described herein, the control message includes a request for a reference signal associated with determining the phase calibration adjustment.

In some examples of the method, UEs, and non-transitory computer-readable medium described herein, communicating the one or more reference signals may include operations, features, means, or instructions for receiving a control message indicating that a position of the UE may have changed from the far field of the second device to the near field of the second device, where determining the phase calibration adjustment may be based on the control message.

Some examples of the method, UEs, and non-transitory computer-readable medium described herein may further include operations, features, means, or instructions for storing the phase calibration adjustment for the first phase value in a table in memory at the UE.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports antenna array calibration for a spherical wavefront-based communications system in accordance with one or more aspects of the present disclosure.

FIG. 2 shows an example of a wireless communications system that supports antenna array calibration for a spherical wavefront-based communications system in accordance with one or more aspects of the present disclosure.

FIG. 3 shows an example of a process flow that supports antenna array calibration for a spherical wavefront-based communications system in accordance with one or more aspects of the present disclosure.

FIGS. 4 and 5 show block diagrams of devices that support antenna array calibration for a spherical wavefront-based communications system in accordance with one or more aspects of the present disclosure.

FIG. 6 shows a block diagram of a communications manager that supports antenna array calibration for a spherical wavefront-based communications system in accordance with one or more aspects of the present disclosure.

FIG. 7 shows a diagram of a system including a device that supports antenna array calibration for a spherical wavefront-based communications system in accordance with one or more aspects of the present disclosure.

FIGS. 8 through 10 show flowcharts illustrating methods that support antenna array calibration for a spherical wavefront-based communications system in accordance with one or more aspects of the present disclosure.

### DETAILED DESCRIPTION

A user equipment (UE) may use beam correspondence to determine uplink beam weights based on beam weights used for downlink signaling or measurements. There may be differences or mismatches between downlink circuitry of the UE and uplink circuitry of the UE, and the UE may determine calibrations or adjustments in terms of phase and amplitude of beam weights to compensate for the differences between uplink circuitry and downlink circuitry. The calibrations may include, for example, phase and amplitude components for each antenna in beamforming. A UE may be preconfigured with calibrations in a test environment prior to deployment of the UE in a wireless communications system. In some wireless communications systems, the calibrations may be configured at the UE based on far field communications or channel conditions implicitly assumed for far field communications. However, when a UE communicates in a near field where a spherical wavefront dominates, different conditions may impact beam correspondence. For example, a network entity may transmit using a spherical wavefront, but the spherical wavefront may appear as a planar wavefront to a UE operating in the far field, such that phase changes from the spherical wavefront are negligible to the UE operating in the far field. In near field communications, phase changes from the spherical wavefront may be more apparent to the UE, such that phase assumptions based on a planar wavefront are not applicable. Therefore, the phase components of the calibrations that are configured based on far field communications may reduce the quality of actual communications, or in other words, these calibrations may not be applicable for near field communications.

A UE may determine phase calibration adjustments for near field communications where spherical wavefront dominates transmissions. For example, the UE may determine a target phase for both far field and near field communications. The UE may be configured with calibrations for the far field to achieve different target beam weights or target phases. The UE may determine an additional phase calibration adjustment to achieve the target phase when operating in the near field. In some examples, the phase calibration adjustments may be based on conditions of the UE or a wireless communications system in which the UE is operating, such as a temperature, one or more gain states, operating frequency, array dimensions of the UE, or any combination thereof. In some examples, the UE may determine the phase calibration adjustment based on signaling with a network entity. For example, the network entity may transmit a set of reference signals to the UE in the near field, and the set of reference signals may have an expected phase in the far field. The UE may measure a phase response with the reference signal of the set of reference signals over antenna elements of the UE to determine a phase calibration adjustment for the near field. In some other examples, the network entity may transmit a reference signal to the UE, and the UE may retransmit the same reference signal to the network entity. The network entity may transmit feedback of the reference signal to the UE, and the UE may determine a phase deviation between the received reference signal and the transmitted reference signal based on the feedback from the network entity. The phase calibration adjustment may correspond to the phase deviation. As such, the UE may phase calibration adjustments to account for near field communications, thereby increasing throughput and reducing communication error rates.

Aspects of the disclosure are initially described in the context of wireless communications systems. Aspects of the disclosure are further illustrated by and described with reference to apparatus diagrams, system diagrams, and flowcharts that relate to antenna array calibration for a spherical wavefront-based communications system.

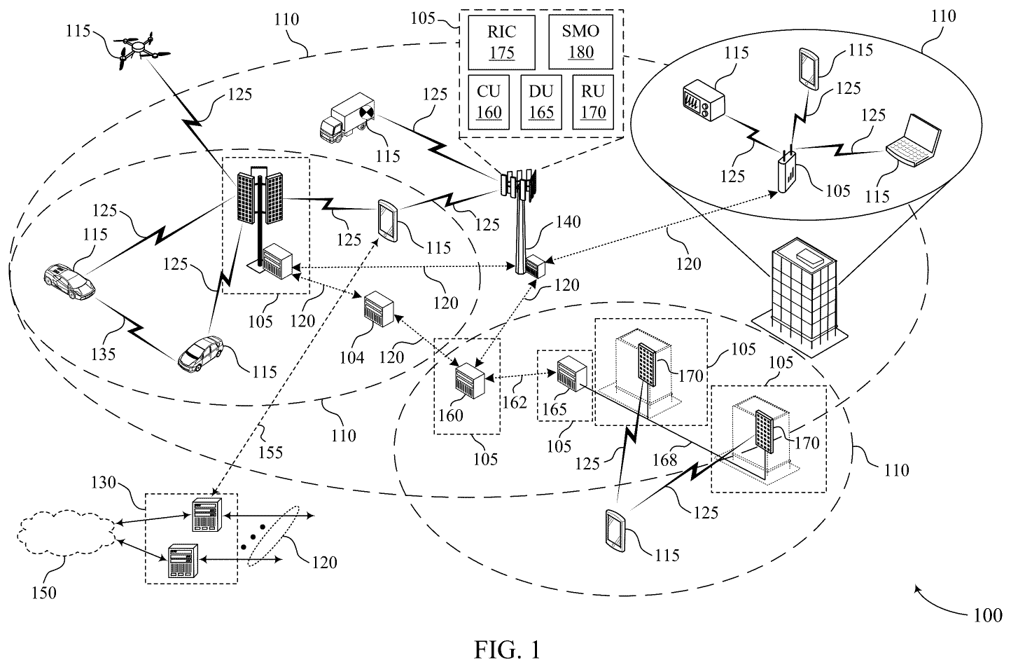

FIG. 1 shows an example of a wireless communications system 100 that supports antenna array calibration for a spherical wavefront-based communications system in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may use beam correspondence to determine uplink beam weights based on beam weights used for downlink signaling. In some cases, there may be uplink-downlink circuit mismatches, and the UE 115 may determine beam calibrations to compensate for the differences between uplink circuitry at the UE 115 and downlink circuitry at the UE 115. For example, given the uplink-downlink circuit mismatches, the UE 115 may determine beam calibration adjustments that compensate for uplink beam weights based on used downlink beam weights. The beam calibrations may include, for example, phase and amplitude components.

Calibration adjustments may be classified as corresponding to characterization (e.g., a one-time operation in a pre-deployment phase done for a set of test/golden devices, which are then re-applied to all the devices in the same device class) or calibration (which are adjustments learned for every device individually). Calibration may be performed in a pre-deployment phase on a per-device basis or in an on-demand manner on a per-device basis. In some cases, a UE 115 may be pre-configured with calibration adjustments, such as from a test environment, prior to deployment of the UE 115 in a wireless communications. In some wireless communications, the calibrations may be configured at the UE 115 based on far field communications or channel conditions for far field communications. For example, the adjustment techniques may consider beam weights for deployment in a far field of a network entity 105.

In some scenarios, larger antenna arrays may be used at a network entity 105, a customer premises equipment (CPE), or a UE 115. For a progressive phase shift of DFT beams with directional transmission, a distance between the center of the transmitter antenna arrays and receiver antenna arrays may be assumed to be large. However, this assumption may not hold for larger antenna arrays, or for small cell coverage where the distance between the antenna arrays could be smaller.

For example, a Hertzian dipole may be placed along a Z axis symmetrically, with d being a radiator size and carrying I (t) Amperes along the Z axis of a gate controlled switch (GCS). At an observation point, r, the magnetic and electric fields due to the single antenna with center at the origin may be provided by Equation (1) and Equation (2), respectively.

$$H = \frac{jkId}{4 π r} \cdot {e}^{- j k r} sin ( θ ) \cdot [ 1 + \frac{1}{j k r} ] \cdot \hat{ϕ} \qquad ( 1 )$$

$$E = \frac{jkId {η}_{0}}{4 π r} \cdot {e}^{- j k r} \cdot ( \frac{1}{j k r} + \frac{1}{{( jkr )}^{2}} ) \hat{r} + sin ( θ ) \cdot ( 1 + \frac{1}{j k r} + \frac{1}{{( jkr )}^{2}} ) \hat{θ} \qquad ( 2 )$$

A far field may be a region where a codebook of progressive phase shift or directional beams (determined by a single distance from the center of the transmit antenna array to the center of the receive antenna array) does not take a substantial performance loss relative to the optimal beam weights. At shorter distances, beam weights may be based on a true distance between antenna element pairs at the transmitter and receiver.

For example, when a UE 115 communicates using near field communication, different conditions may impact beam correspondence. For example, a network entity 105 may transmit using a spherical wavefront, but the spherical wavefront may appear as a planar wavefront to a UE 115 operating in the far field, such that phase changes from the spherical wavefront are negligible to the UE operating in the far field. In near field communications, phase changes from the spherical wavefront may be more apparent to the UE 115, such that phase assumptions for a planar wavefront are not applicable. Therefore, the phase components of the calibrations that are configured based on far field communication may reduce quality or may not be applicable for near field communication.

Phase arrays for millimeter wave frequencies may use radomes for design and construction. An impact of a radome in the near field may be different from the impact of the radome in the far field. In some cases, the effect of a radome in the far field may be in terms of second-order effects which are observable. In the near field, radomes may cause beam squinting and ripples over an effective isotropic radiated power (EIRP) envelope, such as for radomes over large bandwidths. For large phased arrays, optimized radomes in the near field may cause effects which are within accepted tolerances. However, for small-phased arrays, such as those equipped to UEs 115, radome effects may be more substantial. Additionally, other materials used in UE, CPE, or network entity design, such as the housing, may impact performance at near field distances.

A UE 115 may determine phase calibration adjustments for near field communication. For example, the UE 115 may determine a target phase for both far field and near field communication. The UE 115 may be configured with beam calibrations for the far field to achieve different target beam weights or target phases. The UE 115 may determine an additional phase calibration adjustment to achieve the target phase when operating in the near field. In some examples, the phase calibration adjustments may be based on conditions of the UE 115 or the wireless communications system 100, such as a temperature, one or more gain states, operating frequency, or array dimensions, or any combination thereof. In some examples, the UE 115 may determine the phase calibration adjustment based on signaling with a network entity 105. For example, the network entity 105 may transmit a reference signal to the UE 115 in the near field, and the reference signal may have an expected phase in the far field. The UE 115 may measure a phase response of the reference signal over antenna elements of the UE 115 to determine a phase calibration adjustment for the near field. In some other examples, the network entity 105 may transmit a reference signal to the UE 115, and the UE 115 may transmit the same reference signal to the network entity 105. The network entity 105 may transmit feedback of the reference signal to the UE 115, and the UE 115 may determine a phase deviation between the received reference signal and the transmitted reference signal based on the feedback from the network entity 105. The phase calibration adjustment may correspond to the phase deviation.

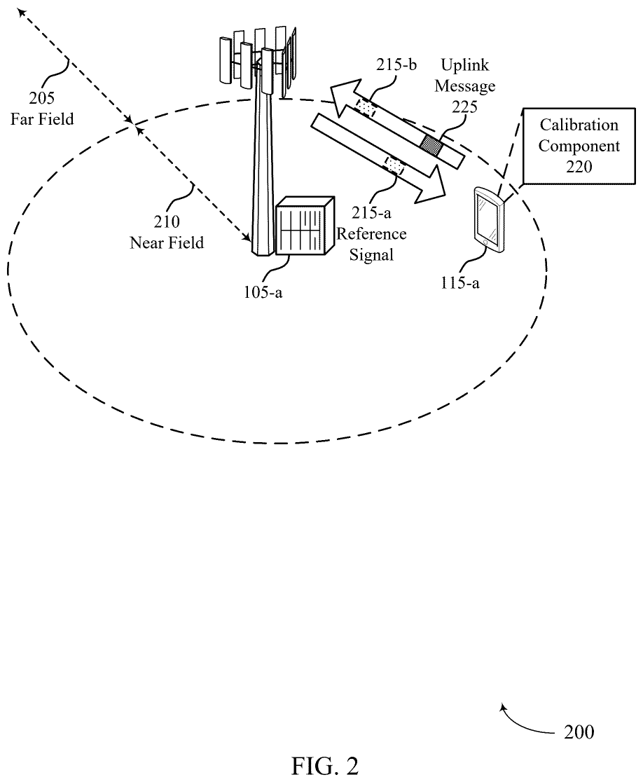

FIG. 2 shows an example of a wireless communications system 200 that supports antenna array calibration for a spherical wavefront-based communications system in accordance with one or more aspects of the present disclosure. The wireless communications system 200 may implement aspects of a wireless communications system 100. For example, the wireless communications system 200 may include a UE 115-a and a network entity 105-b, which may be respective examples of a UE 115 and a network entity 105 as described herein.

The UE 115-a may communicate with the network entity 105-a using multi-antenna beamforming. The UE 115-a may use uplink-downlink beam correspondence to determine uplink beam weights based on downlink beam weights. The UE 115-a may perform calibration adjustments based on mismatches between uplink circuitry of the UE 115-a and downlink circuitry of the UE 115-a.

The UE 115-a may operate in a far field 205 of the network entity 105-a or a near field 210 of the network entity 105-a. The far field may correspond to a geographical area or region where a codebook of progressive phase shifts or directional beams do not take substantial performance loss relative to optimal beam weights. For example, the UE 115-a may be far enough away from the network entity 105-a while operating in the far field that minor changes to beam weights or beam direction cause minor or negligible loss to channel quality or performance. While the UE 115-a operate in the near field 210 of the network entity 105-a, minor changes to beam weights or beam direction may cause a larger change to channel quality or performance. For example, beam weights may be based on a true distance between antenna element pairs (e.g., transmit and receive antenna pairs) at the network entity 105-a and the UE 115-a.

Some adjustments may be performed based on an assumption that the UE 115-a is operating in a far field 205 of the network entity 105-a. The network entity 105-a may transmit signaling using a spherical wavefront. The spherical wavefront may appear as a planar wavefront while the UE 115-a is operating in the far field, such that phase changes are negligible. However, while the UE 115-a is operating in the near field, beam direction changes may result in noticeable phase discrepancies. For example, a phase determined for an uplink beam in the near field 210 based on beam correspondence with a downlink beam may be inaccurate.

The UE 115-a may perform phase calibration adjustments for communications in the near field 210. In some examples, the UE 115-a and the network entity 105-a may communicate reference signals 215 to determine whether the UE 115-a is operating in the near field 210 or the far field 205. For example, the network entity 105-a may transmit a reference signal 215-a to the UE 115-a, or the UE 115-a may transmit a reference signal 215-b to the network entity 105-a. The UE 115-a or the network entity 105-a, or both, may determine whether the UE 115-a is operating in the far field 205 or the near field 210 based on the reference signals or measurements of the reference signals. For example, the UE 115-a may determine the UE 115-a is operating in the near field 210 based on positioning estimates relative to the network entity 105-a.

If the UE 115-a is operating in the near field, the UE 115-a may not assume a planar wavefront for communications between the UE 115-a and the network entity 105-a. The UE 115-a may assume a true distance between pairs of antenna elements between the UE 115-a and the network entity 105-a, or a spherical wavefront model (e.g. model for near field operation).

The UE 115-a may generate calibration adjustments based on far field calibrations. In some examples, the far field calibrations may be stored in memory at the UE 115-a, such as in a lookup table. The UE 115-a may determine additional calibration adjustments for when the UE 115-a is operating in the near field. For example, the UE 115-a may have a set of first values (θ) for a desired phase in the far field 205 and the near field 210, a second set of values (\hat{θ}) for adjustments when operating in the far field 205 (e.g., based on circuitry mismatches), and a third set of values (\hat{θ}+δ) for adjustments when operating in the near field 210 (e.g., based on the circuitry mismatches and assuming a spherical wavefront instead of a planar wavefront). Table 1 provides an example lookup table storing the first set of values, the second set of values, and the third set of values.

TABLE 1

| Desired Phase | | |
|---|---|---|
| (Near and Far Fields) | Far Field Adjustment | Near Field Adjustment |
| θ₁ | \hat{θ}₁ | \hat{θ}₁ + δ₁ |
| θ₂ | \hat{θ}₂ | \hat{θ}₂ + δ₂ |
| θ₃ | \hat{θ}₃ | \hat{θ}₃ + δ₃ |
| . . . | . . . | . . . |

For example, the UE 115-a may select δᵢ for each phase state i as a near field calibration adjustment to compensate for effects from operating in the near field 210. A near field calibration adjustment may come from a B-bit quantization (e.g., where B is a positive integer) or set to zero (e.g., there is no near field adjustment relative to the far field). In some examples, each near field calibration adjustment may be chosen independently for each phase state based on the desired phase value.

In some examples, a near field calibration adjustment may be determined based on one or more other parameters, or one or more conditions of the UE 115-a or the wireless communications system 200, or both. For example, a near field calibration adjustment may be based on an ambient temperature, an operating temperature of the UE 115-a, one or more gain states of one or more antennas or one or more antenna elements of the UE 115-a, an operating frequency of the UE 115-a, antenna array dimensions at the UE 115-a, or any combination thereof.

In some examples, the UE 115-a may determine one or more values for the one or more near field calibration adjustments based on switching from the far field 205 to the near field 210. For example, the UE 115-a may determine one or more near field calibration adjustments in an on-demand manner based on an indication (e.g., from the UE 115-a or the network entity 105-a, or both) that the UE 115-a has changed from operating in the far field 205 to the near field 210. In some cases, a reference signal request, a calibration request, or both, may be transmitted from the UE 115-a or the network entity 105-a, or both, to trigger calibration adjustment in a dynamic manner after determining, by either the UE 115-a or the network entity 105-a, or both, a change from far field to near field operations.

In some examples, the UE 115-a may determine the one or more near field calibration adjustments based on over-the-air signaling. For example, the network entity 105-a may transmit a reference signal (e.g., a known reference signal) with an expected phase response in the far field over a receive antenna array. The UE 115-a may measure the phase response seen over the antenna elements (e.g., one-by-one, in a group of antenna elements, or across all antenna elements together) and adjust the look-up table of near field calibration adjustments accordingly. For example, the network entity 105-a may transmit a reference signal with an expected phase response, the UE 115-a may measure the phase response of the reference signal, and the discrepancy between the expected phase and the near field calibration adjustment may correspond to the measured phase response.

In some examples, the network entity 105-a may transmit a reference signal to the UE 115-a, and the UE 115-a may transmit the reference signal back to the network entity 105-a. For example, the network entity 105-a may transmit a known reference signal to the UE 115-a at a first time, and the UE 115-a may transmit the known reference signal to the network entity 105-b at a second time. The network entity 105-a may transmit feedback information (e.g., phase feedback) to the UE 115-a based on the reference signal received from the UE 115-a. The UE 115-a may determine a phase deviation between the transmit and receive circuitry at the UE 115-a to determine a near field calibration adjustment.

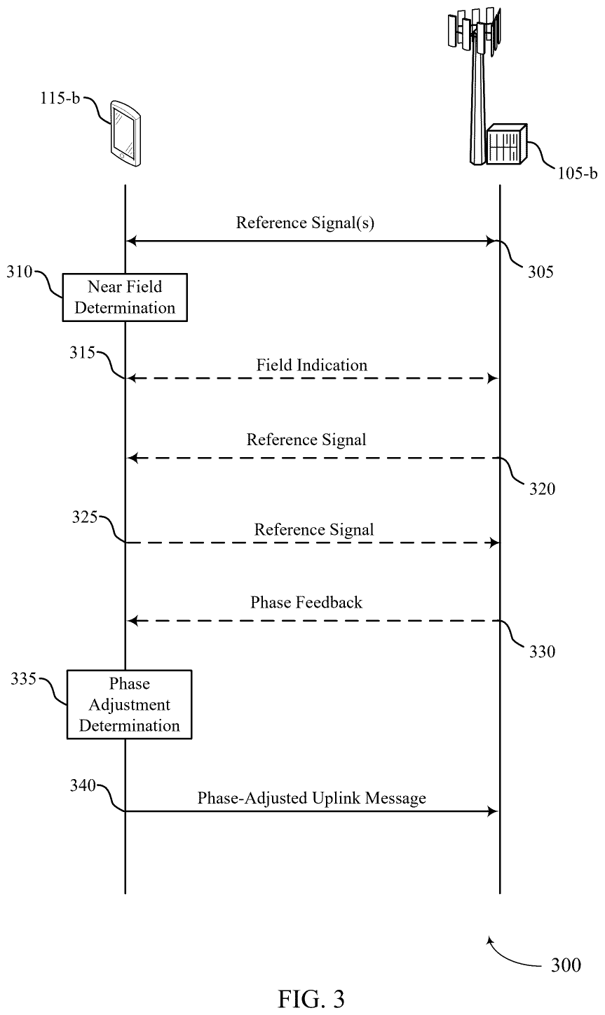

FIG. 3 shows an example of a process flow 300 that supports antenna array calibration for a spherical wavefront-based communications system in accordance with one or more aspects of the present disclosure. The process flow 300 may be implemented by a UE 115-b or a network entity 105-b, or both, which may be respective examples of a UE 115 and a network entity 105 described herein.

Alternative examples of the following may be implemented, where some steps are performed in a different order than described or are not performed at all. In some cases, steps may include additional features not mentioned below, or further steps may be added. Although the UE 115-b and the network entity 105-b are shown performing the operations of the process flow 300, some aspects of some operations may also be performed by one or more other wireless devices.

At 305, the UE 115-b and the network entity 105-b may communicate reference signals. For example, the UE 115-b or the network entity 105-b, or both, may communicate one or more reference signals to identify that communication with a second device (e.g., the network entity 105-b) is in a near field of the second device. The UE 115-b may transmit or receive the one or more reference signals. For example, the UE 115-b may determine that the UE 115-b is operating in the near field of the network entity 105-b at 310. In some examples, the UE 115-b may determine that the UE 115-b is operating in the near field of the network entity 105-b based on positioning estimates from measuring the one or more reference signals.

In some examples, the UE 115-b may transmit or receive an indication that the UE 115-b is operating in the near field of the network entity 105-b at 315. For example, the UE 115-b may transmit a control message indicating that a position of the UE 115-b has changed from the far field of the network entity 105-b to the near field of the network entity 105-b. In some examples, the UE 115-b may receive a control message indicating that a position of the UE 115-b has changed from the far field of the network entity 105-b to the near field of the network entity 105-b.

At 335, the UE 115-b may determine a phase calibration adjustment based on communicating with the network entity 105-b in the near field of the network entity 105-b. For example, the UE 115-b may determine, based on the communication with the network entity 105-b being in the near field, a phase calibration adjustment for a first phase value associated with a far field. In some examples, the UE 115-b may determine the phase calibration adjustment based on an ambient temperature, a temperature associated with the UE 115-b, a gain state of the UE 115-b, a radio frequency spectrum band used to communications with the network entity 105-b, a dimension of an antenna array of the UE 115-b, or any combination thereof. In some examples, the UE 115-b may store the phase calibration adjustment for the first phase value in a table in memory at the UE 115-b.

In some examples, the UE 115-b may determine the phase calibration adjustment based on over-the-air signaling. For example, the UE 115-b may receive a reference signal associated with a first phase based on the communication with the network entity 105-b being in the near field at 320, and the UE 115-b may measure a phase response of the reference signal over one or more antenna elements. The phase calibration adjustment may be based on the phase response of the reference signal.

In some examples, the UE 115-b may receive a first reference signal associated with a first phase based on the communication with the network entity 105-b being in the near field at 320. At 325, the UE 115-b may transmit a second reference signal associated with the first phase based on receiving the first reference signal associated with the first phase. The UE 115-b may receive, at 330, feedback information indicating a phase deviation between the first reference signal and the second reference signal. The phase calibration adjustment may be based on the phase deviation between the first reference signal and the second reference.

In some examples, the UE 115-b may determine multiple phase calibration adjustments. For example, the UE 115-b may determine, for each of multiple sets of phase values associated with far field communications, a corresponding phase calibration adjustment. For example, the UE 115-b may determine a phase calibration adjustment for each of multiple phase states or desired phases. In some examples, a phase calibration adjustment may be zero, or there may be no difference between a phase used for near field and far field.

At 340, the UE 115-b may transmit a phase-adjusted uplink message to the network entity 105-b. For example, the UE 115-b may transmit, based on the communication with the network entity 105-b being in the near field, a message according to the first phase value and the phase calibration adjustment. By applying the phase calibration adjustment, the UE 115-b may modify a phase value such that the uplink message has a desired phase for the far field while the UE 115-b operates in the near field.

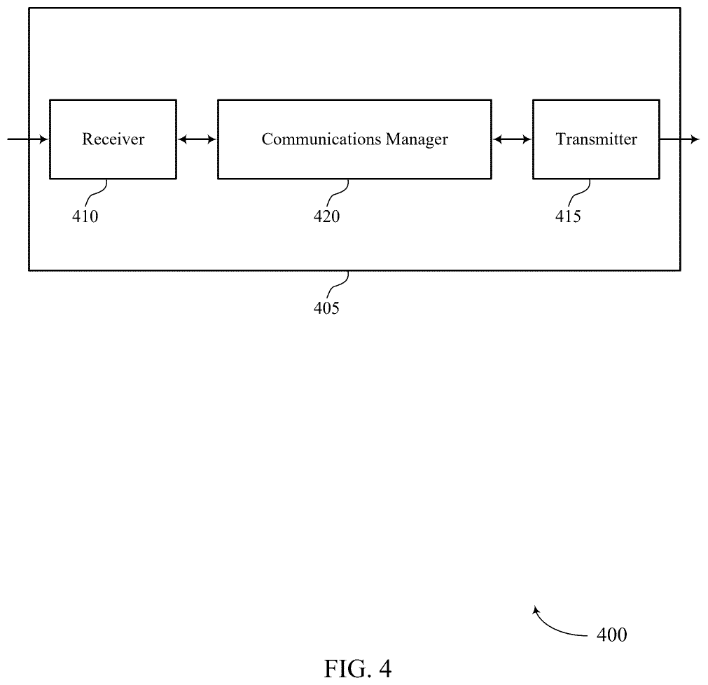

FIG. 4 shows a block diagram 400 of a device 405 that supports antenna array calibration for a spherical wavefront-based communications system in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to antenna array calibration for a spherical wavefront-based communications system). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to antenna array calibration for a spherical wavefront-based communications system). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of antenna array calibration for a spherical wavefront-based communications system as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for communicating one or more reference signals to identify that communication with a second device is in a near field of the second device. The communications manager 420 is capable of, configured to, or operable to support a means for determining, based on the communication with the second device being in the near field, a phase calibration adjustment for a first phase value associated with a far field. The communications manager 420 is capable of, configured to, or operable to support a means for transmitting, based on the communication with the second device being in the near field, a message according to the first phase value and the phase calibration adjustment.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for improved communications performance when operating in a near field.

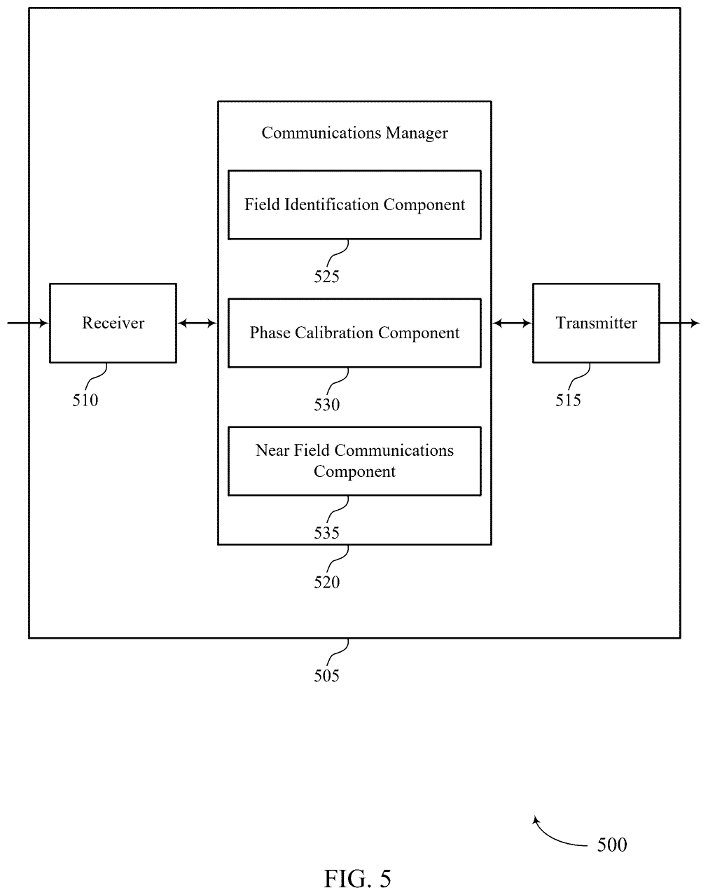

FIG. 5 shows a block diagram 500 of a device 505 that supports antenna array calibration for a spherical wavefront-based communications system in accordance with one or more aspects of the present disclosure. The device 505 may be an example of aspects of a device 405 or a UE 115 as described herein. The device 505 may include a receiver 510, a transmitter 515, and a communications manager 520. The device 505, or one of more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to antenna array calibration for a spherical wavefront-based communications system). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to antenna array calibration for a spherical wavefront-based communications system). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of antenna array calibration for a spherical wavefront-based communications system as described herein. For example, the communications manager 520 may include a field identification component 525, a phase calibration component 530, a near field communications component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The field identification component 525 is capable of, configured to, or operable to support a means for communicating one or more reference signals to identify that communication with a second device is in a near field of the second device. The phase calibration component 530 is capable of, configured to, or operable to support a means for determining, based on the communication with the second device being in the near field, a phase calibration adjustment for a first phase value associated with a far field. The near field communications component 535 is capable of, configured to, or operable to support a means for transmitting, based on the communication with the second device being in the near field, a message according to the first phase value and the phase calibration adjustment.

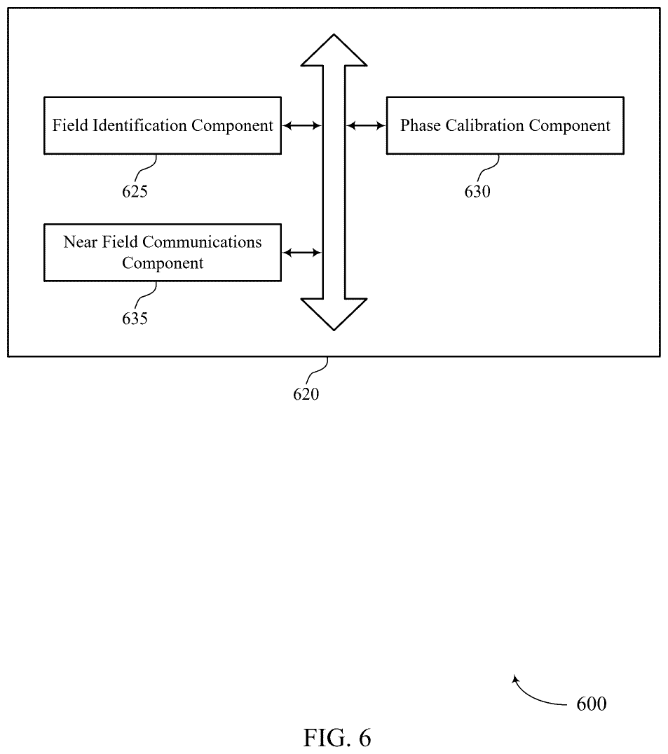

FIG. 6 shows a block diagram 600 of a communications manager 620 that supports antenna array calibration for a spherical wavefront-based communications system in accordance with one or more aspects of the present disclosure. The communications manager 620 may be an example of aspects of a communications manager 420, a communications manager 520, or both, as described herein. The communications manager 620, or various components thereof, may be an example of means for performing various aspects of antenna array calibration for a spherical wavefront-based communications system as described herein. For example, the communications manager 620 may include a field identification component 625, a phase calibration component 630, a near field communications component 635, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The field identification component 625 is capable of, configured to, or operable to support a means for communicating one or more reference signals to identify that communication with a second device is in a near field of the second device. The phase calibration component 630 is capable of, configured to, or operable to support a means for determining, based on the communication with the second device being in the near field, a phase calibration adjustment for a first phase value associated with a far field. The near field communications component 635 is capable of, configured to, or operable to support a means for transmitting, based on the communication with the second device being in the near field, a message according to the first phase value and the phase calibration adjustment.

In some examples, to support determining the phase calibration adjustment, the phase calibration component 630 is capable of, configured to, or operable to support a means for receiving a reference signal associated with a first phase based on the communication with the second device being in the near field. In some examples, to support determining the phase calibration adjustment, the phase calibration component 630 is capable of, configured to, or operable to support a means for measuring a phase response of the reference signal over one or more antenna elements of the UE, where the phase calibration adjustment is based on the phase response of the reference signal.

In some examples, to support determining the phase calibration adjustment, the phase calibration component 630 is capable of, configured to, or operable to support a means for receiving a first reference signal associated with a first phase based on the communication with the second device being in the near field. In some examples, to support determining the phase calibration adjustment, the phase calibration component 630 is capable of, configured to, or operable to support a means for transmitting a second reference signal associated with the first phase based on the first reference signal associated with the first phase. In some examples, to support determining the phase calibration adjustment, the phase calibration component 630 is capable of, configured to, or operable to support a means for receiving a feedback message indicating a phase deviation between the first reference signal and the second reference signal, where the phase calibration adjustment is based on the phase deviation.

In some examples, to support determining the phase calibration adjustment, the phase calibration component 630 is capable of, configured to, or operable to support a means for determining, for each of a set of multiple sets of phase values associated with far field communications, a corresponding phase calibration adjustment.

In some examples, the phase calibration adjustment is based on an ambient temperature, a temperature associated with the UE, a gain state of the UE, a radio frequency spectrum band used to transmit the message, a dimension of an antenna array of the UE, or any combination thereof.

In some examples, to support communicating the one or more reference signals, the field identification component 625 is capable of, configured to, or operable to support a means for receiving a reference signal, where a measurement of the reference signal is indicative that a position of the UE corresponds to being in the near field.

In some examples, the field identification component 625 is capable of, configured to, or operable to support a means for transmitting a control message indicating that a position of the UE has changed from the far field of the second device to the near field of the second device, where determining the phase calibration adjustment is based on the control message.

In some examples, the control message includes a request for a reference signal associated with determining the phase calibration adjustment.

In some examples, to support communicating the one or more reference signals, the field identification component 625 is capable of, configured to, or operable to support a means for receiving a control message indicating that a position of the UE has changed from the far field of the second device to the near field of the second device, where determining the phase calibration adjustment is based on the control message.

In some examples, the phase calibration component 630 is capable of, configured to, or operable to support a means for storing the phase calibration adjustment for the first phase value in a table in memory at the UE.

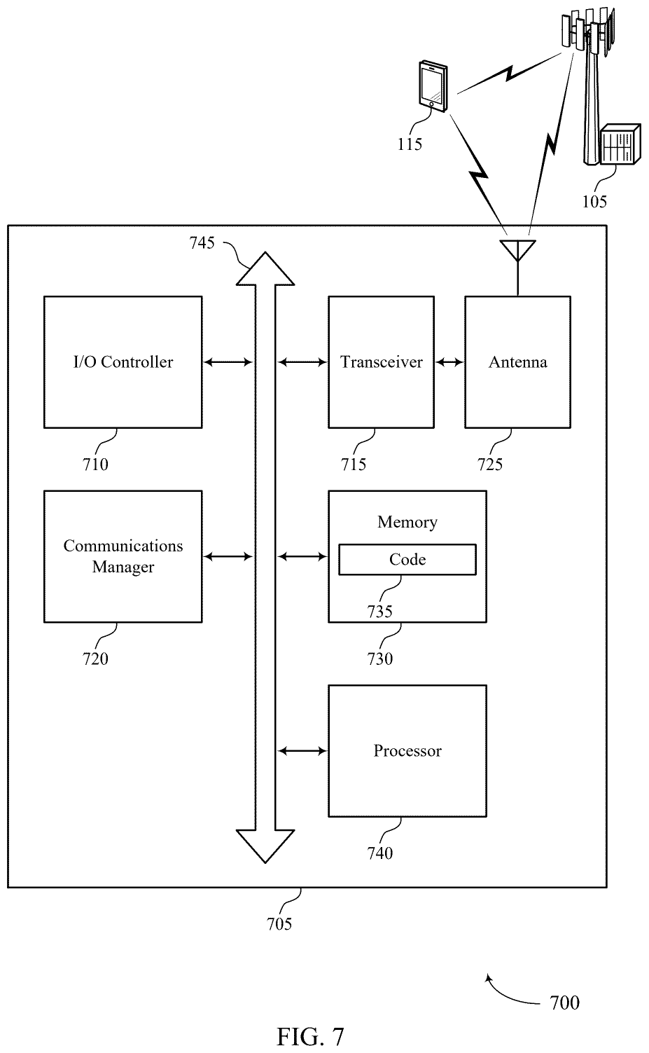

FIG. 7 shows a diagram of a system 700 including a device 705 that supports antenna array calibration for a spherical wavefront-based communications system in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting antenna array calibration for a spherical wavefront-based communications system). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for communicating one or more reference signals to identify that communication with a second device is in a near field of the second device. The communications manager 720 is capable of, configured to, or operable to support a means for determining, based on the communication with the second device being in the near field, a phase calibration adjustment for a first phase value associated with a far field. The communications manager 720 is capable of, configured to, or operable to support a means for transmitting, based on the communication with the second device being in the near field, a message according to the first phase value and the phase calibration adjustment.

By including or configuring the communications manager 720 in accordance with examples as described herein, the device 705 may support techniques for improved communication reliability, and improved coordination between devices.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of antenna array calibration for a spherical wavefront-based communications system as described herein, or the at least one processor 740 and the at least one memory 730 may be otherwise configured to, individually or collectively, perform or support such operations.

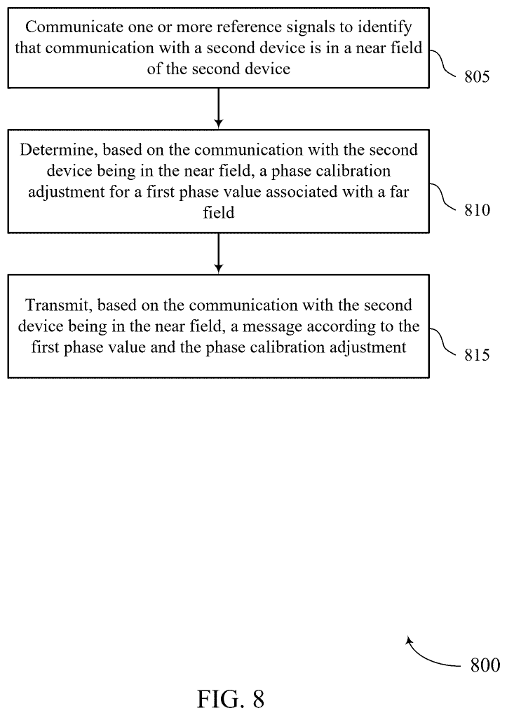

FIG. 8 shows a flowchart illustrating a method 800 that supports antenna array calibration for a spherical wavefront-based communications system in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include communicating one or more reference signals to identify that communication with a second device is in a near field of the second device. The operations of 805 may be performed in accordance with examples as disclosed herein. In some examples, aspects of the operations of 805 may be performed by a field identification component 625 as described with reference to FIG. 6.

At 810, the method may include determining, based on the communication with the second device being in the near field, a phase calibration adjustment for a first phase value associated with a far field. The operations of 810 may be performed in accordance with examples as disclosed herein. In some examples, aspects of the operations of 810 may be performed by a phase calibration component 630 as described with reference to FIG. 6.

At 815, the method may include transmitting, based on the communication with the second device being in the near field, a message according to the first phase value and the phase calibration adjustment. The operations of 815 may be performed in accordance with examples as disclosed herein. In some examples, aspects of the operations of 815 may be performed by a near field communications component 635 as described with reference to FIG. 6.

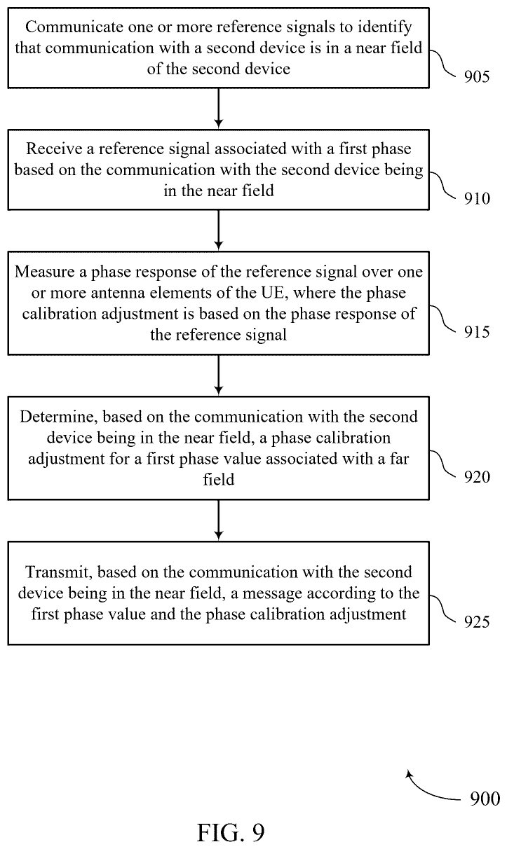

FIG. 9 shows a flowchart illustrating a method 900 that supports antenna array calibration for a spherical wavefront-based communications system in accordance with one or more aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include communicating one or more reference signals to identify that communication with a second device is in a near field of the second device. The operations of 905 may be performed in accordance with examples as disclosed herein. In some examples, aspects of the operations of 905 may be performed by a field identification component 625 as described with reference to FIG. 6.

At 910, the method may include receiving a reference signal associated with a first phase based on the communication with the second device being in the near field. The operations of 910 may be performed in accordance with examples as disclosed herein. In some examples, aspects of the operations of 910 may be performed by a phase calibration component 630 as described with reference to FIG. 6.

At 915, the method may include measuring a phase response of the reference signal over one or more antenna elements of the UE, where the phase calibration adjustment is based on the phase response of the reference signal. The operations of 915 may be performed in accordance with examples as disclosed herein. In some examples, aspects of the operations of 915 may be performed by a phase calibration component 630 as described with reference to FIG. 6.

At 920, the method may include determining, based on the communication with the second device being in the near field, a phase calibration adjustment for a first phase value associated with a far field. The operations of 920 may be performed in accordance with examples as disclosed herein. In some examples, aspects of the operations of 920 may be performed by a phase calibration component 630 as described with reference to FIG. 6.

At 925, the method may include transmitting, based on the communication with the second device being in the near field, a message according to the first phase value and the phase calibration adjustment. The operations of 925 may be performed in accordance with examples as disclosed herein. In some examples, aspects of the operations of 925 may be performed by a near field communications component 635 as described with reference to FIG. 6.

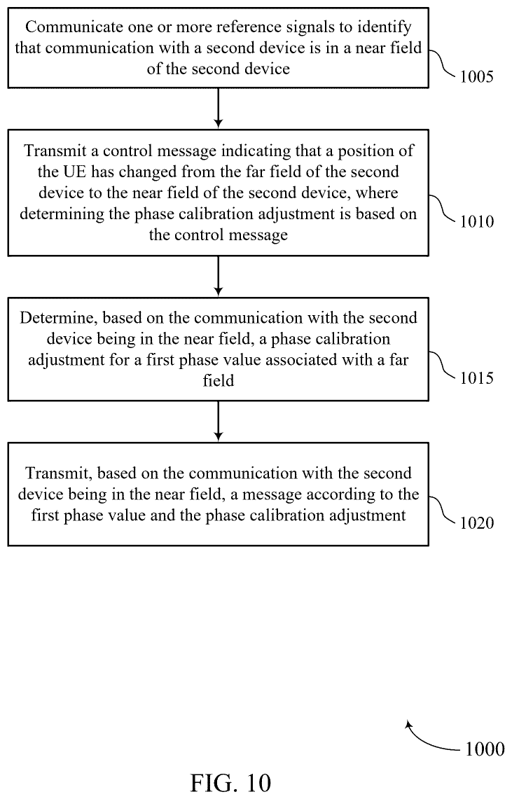

FIG. 10 shows a flowchart illustrating a method 1000 that supports antenna array calibration for a spherical wavefront-based communications system in accordance with one or more aspects of the present disclosure. The operations of the method 1000 may be implemented by a UE or its components as described herein. For example, the operations of the method 1000 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1005, the method may include communicating one or more reference signals to identify that communication with a second device is in a near field of the second device. The operations of 1005 may be performed in accordance with examples as disclosed herein. In some examples, aspects of the operations of 1005 may be performed by a field identification component 625 as described with reference to FIG. 6.

At 1010, the method may include transmitting a control message indicating that a position of the UE has changed from the far field of the second device to the near field of the second device, where determining the phase calibration adjustment is based on the control message. The operations of 1010 may be performed in accordance with examples as disclosed herein. In some examples, aspects of the operations of 1010 may be performed by a field identification component 625 as described with reference to FIG. 6.

At 1015, the method may include determining, based on the communication with the second device being in the near field, a phase calibration adjustment for a first phase value associated with a far field. The operations of 1015 may be performed in accordance with examples as disclosed herein. In some examples, aspects of the operations of 1015 may be performed by a phase calibration component 630 as described with reference to FIG. 6.

At 1020, the method may include transmitting, based on the communication with the second device being in the near field, a message according to the first phase value and the phase calibration adjustment. The operations of 1020 may be performed in accordance with examples as disclosed herein. In some examples, aspects of the operations of 1020 may be performed by a near field communications component 635 as described with reference to FIG. 6.

The following provides an overview of aspects of the present disclosure:
Aspect 1: A method for wireless communications at a UE, comprising: communicating one or more reference signals to identify that communication with a second device is in a near field of the second device; determining, based at least in part on the communication with the second device being in the near field, a phase calibration adjustment for a first phase value associated with a far field; and transmitting, based at least in part on the communication with the second device being in the near field, a message according to the first phase value and the phase calibration adjustment.
Aspect 2: The method of aspect 1, wherein determining the phase calibration adjustment comprises: receiving a reference signal associated with a first phase based at least in part on the communication with the second device being in the near field; and measuring a phase response of the reference signal over one or more antenna elements of the UE, wherein the phase calibration adjustment is based at least in part on the phase response of the reference signal.
Aspect 3: The method of any of aspects 1 through 2, wherein determining the phase calibration adjustment comprises: receiving a first reference signal associated with a first phase based at least in part on the communication with the second device being in the near field; transmitting a second reference signal associated with the first phase based at least in part on the first reference signal associated with the first phase; and receiving a feedback message indicating a phase deviation between the first reference signal and the second reference signal, wherein the phase calibration adjustment is based at least in part on the phase deviation.
Aspect 4: The method of any of aspects 1 through 3, wherein determining the phase calibration adjustment comprises: determining, for each of a plurality of sets of phase values associated with far field communications, a corresponding phase calibration adjustment.
Aspect 5: The method of any of aspects 1 through 4, wherein the phase calibration adjustment is based at least in part on an ambient temperature, a temperature associated with the UE, a gain state of the UE, a radio frequency spectrum band used to transmit the message, a dimension of an antenna array of the UE, or any combination thereof.
Aspect 6: The method of any of aspects 1 through 5, wherein communicating the one or more reference signals comprises: receiving a reference signal, wherein a measurement of the reference signal is indicative that a position of the UE corresponds to being in the near field.
Aspect 7: The method of any of aspects 1 through 6, further comprising: transmitting a control message indicating that a position of the UE has changed from the far field of the second device to the near field of the second device, wherein determining the phase calibration adjustment is based at least in part on the control message.
Aspect 8: The method of aspect 7, wherein the control message comprises a request for a reference signal associated with determining the phase calibration adjustment.
Aspect 9: The method of any of aspects 1 through 8, wherein communicating the one or more reference signals comprises: receiving a control message indicating that a position of the UE has changed from the far field of the second device to the near field of the second device, wherein determining the phase calibration adjustment is based at least in part on the control message.
Aspect 10: The method of any of aspects 1 through 9, further comprising: storing the phase calibration adjustment for the first phase value in a table in memory at the UE.
Aspect 11: A UE for wireless communications, comprising one or more memories storing processor-executable code, and one or more processors coupled with the one or more memories and individually or collectively operable to execute the code to cause the UE to perform a method of any of aspects 1 through 10.
Aspect 12: A UE for wireless communications, comprising at least one means for performing a method of any of aspects 1 through 10.
Aspect 13: A non-transitory computer-readable medium storing code for wireless communications, the code comprising instructions executable by one or more processors to perform a method of any of aspects 1 through 10.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
communicate one or more reference signals to identify that communication with a second device is in a near field of the second device;
determine, based at least in part on the communication with the second device being in the near field, a phase calibration adjustment for a first phase value associated with a far field; and
transmit, based at least in part on the communication with the second device being in the near field, a message according to the first phase value and the phase calibration adjustment.

2. The UE of claim 1, wherein, to determine the phase calibration adjustment, the one or more processors are individually or collectively operable to execute the code to cause the UE to:
receive a reference signal associated with a first phase based at least in part on the communication with the second device being in the near field; and
measure a phase response of the reference signal over one or more antenna elements of the UE, wherein the phase calibration adjustment is based at least in part on the phase response of the reference signal.

3. The UE of claim 1, wherein, to determine the phase calibration adjustment, the one or more processors are individually or collectively operable to execute the code to cause the UE to:
receive a first reference signal associated with a first phase based at least in part on the communication with the second device being in the near field;
transmit a second reference signal associated with the first phase based at least in part on the first reference signal associated with the first phase; and
receive a feedback message indicating a phase deviation between the first reference signal and the second reference signal, wherein the phase calibration adjustment is based at least in part on the phase deviation.

4. The UE of claim 1, wherein, to determine the phase calibration adjustment, the one or more processors are individually or collectively operable to execute the code to cause the UE to:
determine, for each of a plurality of sets of phase values associated with far field communications, a corresponding phase calibration adjustment.

5. The UE of claim 1, wherein the phase calibration adjustment is based at least in part on an ambient temperature, a temperature associated with the UE, a gain state of the UE, a radio frequency spectrum band used to transmit the message, a dimension of an antenna array of the UE, or any combination thereof.

6. The UE of claim 1, wherein, to communicate the one or more reference signals, the one or more processors are individually or collectively operable to execute the code to cause the UE to:
receive a reference signal, wherein a measurement of the reference signal is indicative that a position of the UE corresponds to being in the near field.

7. The UE of claim 1, wherein the one or more processors are individually or collectively further operable to execute the code to cause the UE to:
transmit a control message indicating that a position of the UE has changed from the far field of the second device to the near field of the second device, wherein the phase calibration adjustment is based at least in part on the control message.

8. The UE of claim 7, wherein the control message comprises a request for a reference signal associated with the phase calibration adjustment.

9. The UE of claim 1, wherein, to communicate the one or more reference signals, the one or more processors are individually or collectively operable to execute the code to cause the UE to:
receive a control message indicating that a position of the UE has changed from the far field of the second device to the near field of the second device, wherein the phase calibration adjustment is based at least in part on the control message.

10. The UE of claim 1, wherein the one or more processors are individually or collectively further operable to execute the code to cause the UE to:
store the phase calibration adjustment for the first phase value in a table in memory at the UE.

11. A method for wireless communications at a user equipment (UE), comprising:
communicating one or more reference signals to identify that communication with a second device is in a near field of the second device;
determining, based at least in part on the communication with the second device being in the near field, a phase calibration adjustment for a first phase value associated with a far field; and
transmitting, based at least in part on the communication with the second device being in the near field, a message according to the first phase value and the phase calibration adjustment.

12. The method of claim 11, wherein determining the phase calibration adjustment comprises:
receiving a reference signal associated with a first phase based at least in part on the communication with the second device being in the near field; and
measuring a phase response of the reference signal over one or more antenna elements of the UE, wherein the phase calibration adjustment is based at least in part on the phase response of the reference signal.

13. The method of claim 11, wherein determining the phase calibration adjustment comprises:
receiving a first reference signal associated with a first phase based at least in part on the communication with the second device being in the near field;
transmitting a second reference signal associated with the first phase based at least in part on the first reference signal associated with the first phase; and
receiving a feedback message indicating a phase deviation between the first reference signal and the second reference signal, wherein the phase calibration adjustment is based at least in part on the phase deviation.

14. The method of claim 11, wherein determining the phase calibration adjustment comprises:
determining, for each of a plurality of sets of phase values associated with far field communications, a corresponding phase calibration adjustment.

15. The method of claim 11, wherein the phase calibration adjustment is based at least in part on an ambient temperature, a temperature associated with the UE, a gain state of the UE, a radio frequency spectrum band used to transmit the message, a dimension of an antenna array of the UE, or any combination thereof.

16. The method of claim 11, wherein communicating the one or more reference signals comprises:
receiving a reference signal, wherein a measurement of the reference signal is indicative that a position of the UE corresponds to being in the near field.

17. The method of claim 11, further comprising:
transmitting a control message indicating that a position of the UE has changed from the far field of the second device to the near field of the second device, wherein determining the phase calibration adjustment is based at least in part on the control message.

18. The method of claim 17, wherein the control message comprises a request for a reference signal associated with determining the phase calibration adjustment.

19. The method of claim 11, wherein communicating the one or more reference signals comprises:
receiving a control message indicating that a position of the UE has changed from the far field of the second device to the near field of the second device, wherein determining the phase calibration adjustment is based at least in part on the control message.

20. A non-transitory computer-readable medium storing code for wireless communications, the code comprising instructions executable by one or more processors to:
communicate one or more reference signals to identify that communication with a second device is in a near field of the second device;
determine, based at least in part on the communication with the second device being in the near field, a phase calibration adjustment for a first phase value associated with a far field; and
transmit, based at least in part on the communication with the second device being in the near field, a message according to the first phase value and the phase calibration adjustment.
